(19) United States
(12) Patent Application Publication
(10) Pub. No.: US 2019/0064547 A1
(43) Pub. Date: Feb. 28, 2019

(54) PHOTOCHROMIC OPHTHALMIC LENS AND METHOD FOR MAKING THE SAME

(71) Applicant: HON HAI PRECISION INDUSTRY CO., LTD., New Taipei (TW)

(72) Inventor: HSIU-WEN CHIEN, New Taipei (TW)

(21) Appl. No.: 15/686,252

(22) Filed: Aug. 25, 2017

(30) Foreign Application Priority Data
Aug. 22, 2017 (TW) 106128479

(51) Int. Cl. G02C 7/10; C03C 17/30

(52) U.S. Cl. CPC G02C 7/102; C03C 2218/111; C03C 17/30

(57) ABSTRACT

A photochromic ophthalmic lens includes a body and a photochromic layer formed on each opposing surface of the body. Photochromic molecule-cyclodextrin inclusion compounds are dispersed in the photochromic layer. The photochromic molecule-cyclodextrin inclusion compounds includes cyclodextrins and photochromic molecules entrapped in a cavity of the cyclodextrins. A gradation of the self-darkening properties can be applied to the photochromic layers.

### FIELD

The subject matter herein generally relates to ophthalmic lenses, and more particularly, to a photochromic ophthalmic lens and a method for making the photochromic ophthalmic lens.

### BACKGROUND

Photochromic ophthalmic lenses have the ability to darken when exposed to certain light (such as sunlight). However, it is often the whole photochromic ophthalmic lens which changes color upon the exposure to light.

### BRIEF DESCRIPTION OF THE DRAWINGS

Implementations of the present technology will now be described, by way of example only, with reference to the attached figures.

FIG. 1 is a flowchart of an exemplary embodiment of a method for making a photochromic ophthalmic lens.

FIG. 2 is a diagram of a photochromic coating solution used in the method in FIG. 1.

FIG. 3 is a diagram showing an ophthalmic lens body immersed in the photochromic coating solution of FIG. 2.

FIG. 4 is a diagram showing the ophthalmic lens body of FIG. 3 exposed to ultraviolet radiation.

FIG. 5 is a diagram of a photochromic ophthalmic lens formed by the ultraviolet radiation of FIG. 4.

FIG. 6A shows a hydrolysis stage of a silylation reaction illustrated in FIG. 4.

FIG. 6B shows a condensation stage after the hydrolysis stage of the silylation reaction illustrated in FIG. 6A.

FIG. 6C shows a hydrogen bond forming stage after the condensation stage of the reaction silylation of FIG. 6B.

FIG. 6D shows a covalent bond forming stage after the hydrogen bond forming stage of the silylation reaction of FIG. 6C.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean at least one.

The term “comprising,” when utilized, means “including, but not necessarily limited to”; it specifically indicates open-ended inclusion or membership in the so-described combination, group, series, and the like.

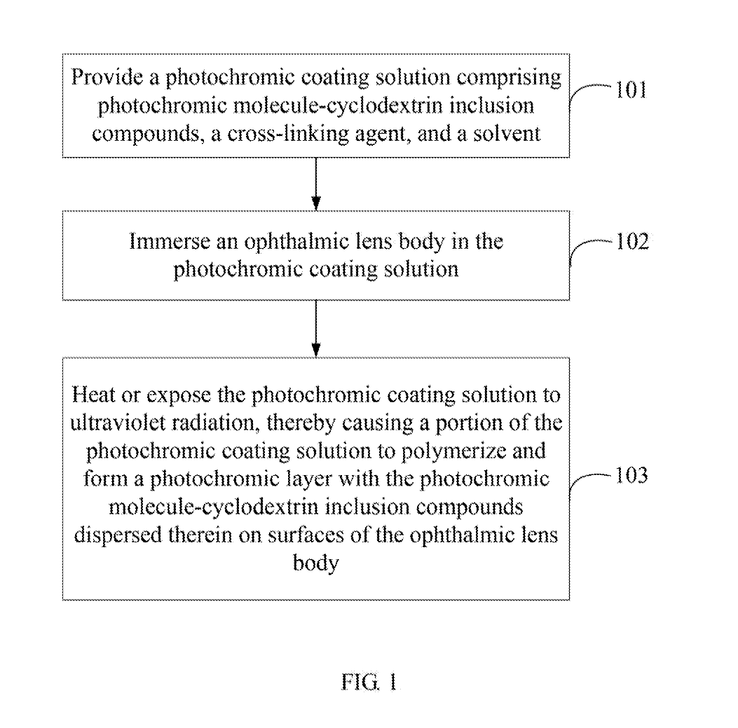

FIG. 1 illustrates a flowchart of an embodiment for a method for making a photochromic ophthalmic lens. The exemplary method is provided by way of example, as there are a variety of ways to carry out the method. Each block shown in the figure represents one or more processes, methods, or subroutines, carried out in the exemplary method. Furthermore, the illustrated order of blocks is by example only, and the order of the blocks can change. Additional blocks may be added or fewer blocks may be utilized, without departing from this disclosure. The exemplary method can begin at block 101.

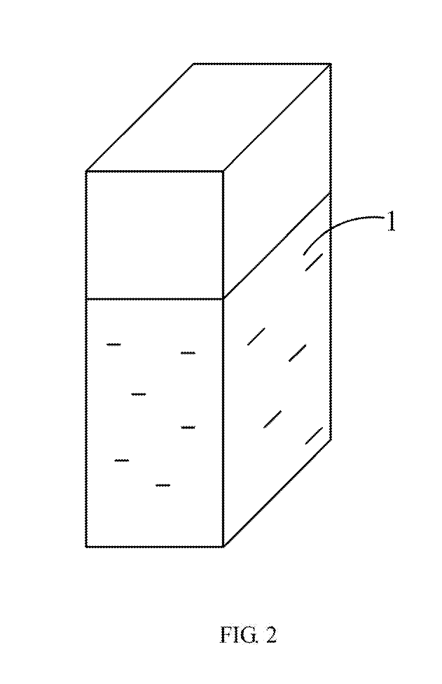

At block 101, referring to FIG. 2, a photochromic coating solution 1 is provided that comprises photochromic molecule-cyclodextrin inclusion compounds, a cross-linking agent, and a solvent.

The photochromic molecule-cyclodextrin inclusion compounds comprise cyclodextrins and photochromic molecules entrapped in a cavity of the cyclodextrins. The cyclodextrins are hydrophobic inside the cavity, and thus able to host other hydrophobic molecules such as photochromic molecules. Furthermore, the cyclodextrins are hydrophilic outside. Thus, the formation of the photochromic molecule-cyclodextrin inclusion compounds can modify the water solubility of the photochromic molecules, without affecting the photochromic property of the photochromic molecules.

In at least one exemplary embodiment, the photochromic molecules can be selected from a group consisting of spiropyrans, spiroperimidines, diarylethenes, fulgides, hexaarylbiimidazole, azobenzenes, benzopyrylospiran, and any combination thereof.

In at least one exemplary embodiment, the cyclodextrins are cyclodextrin derivatives formed by modifying cyclodextrins by methacrylates. The cyclodextrin derivatives have methacrylate groups, and have a chemical diagram of

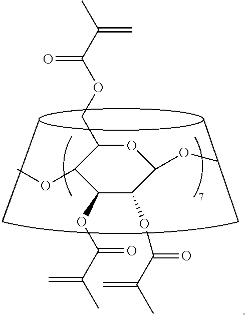

In at least one exemplary embodiment, the formation of the photochromic molecule-cyclodextrin inclusion compounds can be carried out by adding the photochromic molecules in ethanol, tetrahydrofuran, or acetone to form a photochromic solution. The cyclodextrins are added in water to form a cyclodextrin solution. The photochromic solution and the cyclodextrin solution are mixed to form a mixed solution. The mixed solution is stirred to cause the photochromic molecules to be entrapped in the cavity of the cyclodextrins, thereby forming the photochromic molecule-cyclodextrin inclusion compounds. Finally, the photochromic molecule-cyclodextrin inclusion compounds are separated from the mixed solution. In at least one exemplary embodiment, the photochromic molecules have a concentration of about 0.0001 mol/L to about 0.1 mol/L in the photochromic solution. The cyclodextrins have a concentration of about 0.0001 mol/L to about 0.1 mol/L in the cyclodextrin solution.

The cross-linking agent comprises a methacrylate resin, a methacrylate-bonded silane coupling agent, and an initiator.

A silane coupling agent (general formula: YSi(OMe)₃) comprises an unhydrolyzable group Y for bonding organic materials and a hydrolyzable group Si—(OMe)₃ for bonding inorganic materials. The methacrylate-bonded silane coupling agent is formed by bonding methacrylates to the unhydrolyzable group Y of the silane coupling agent. The methacrylate-bonded silane coupling agent has a general formula of RSi(OMe)₃, where R represents methacrylate groups. In at least one exemplary embodiment, the methacrylate-bonded silane coupling agent can be 3-(trimethoxysilyl)propyl methacrylate (TMSPMA).

The initiator may be a photoinitiator or a thermal initiator. The photoinitiator may be selected from a group consisting of benzoin methyl ether, diethoxyacetophenone, benzoylphosphine oxide initiator, 1-hydroxycyclohexyl phenyl ketone, Darocure type initiator, Irgacure type initiator, and any combination thereof. The benzoylphosphine oxide initiator may be selected from a group consisting of 2,4,6-trimethylbenzoyldiphenylophosphine oxide, bis-(2,6-dichlorobenzoyl)-4-N-propylphenylphosphine oxide, and bis-(2,6-dichlorobenzoyl)-4-N-butylphenylphosphine oxide. The Irgacure type initiator can be Irgacure-1173 (trade name, available commercially from Chemical Industries Basel Corporation as a clear liquid). The thermal initiator may be selected from a group consisting of 2,2′-azobis (2,4-dimethylpentanenitrile), 2,2′-azobis (2-methylpropanenitrile), 2,2′-azobis (2-methylbutanenitrile), azobisisobutyronite (AIBN), peroxides (such as benzoyl peroxide), and any combination thereof.

The solvent can be a hydrophilic solvent. In at least one exemplary embodiment, the solvent is alcohol or a mixed solution comprising water and alcohol. For example, the solvent can be ethanol.

The photochromic molecule-cyclodextrin inclusion compounds have a mass percentage of about 11% to about 83% of a total mass of the photochromic coating solution 1. The methacrylate resin has a mass percentage of about 11% to about 41% of the total mass of the photochromic coating solution 1. The methacrylate-bonded silane coupling agent has a mass percentage of about 2% to about 32% of the total mass of the photochromic coating solution 1. The initiator has a mass percentage of about 0.05% to about 10% of the total mass of the photochromic coating solution 1. The solvent has a mass percentage of about 10% to about 71.5% of the total mass of the photochromic coating solution 1.

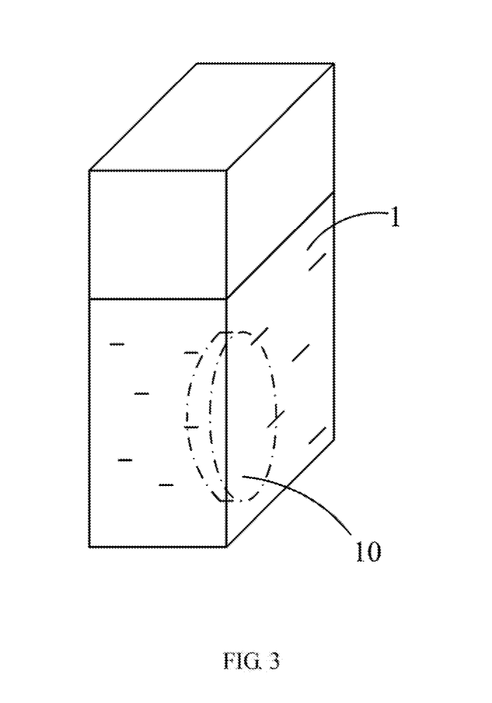

At block 102, referring to FIG. 3, an ophthalmic lens body 10 is immersed in the photochromic coating solution 1.

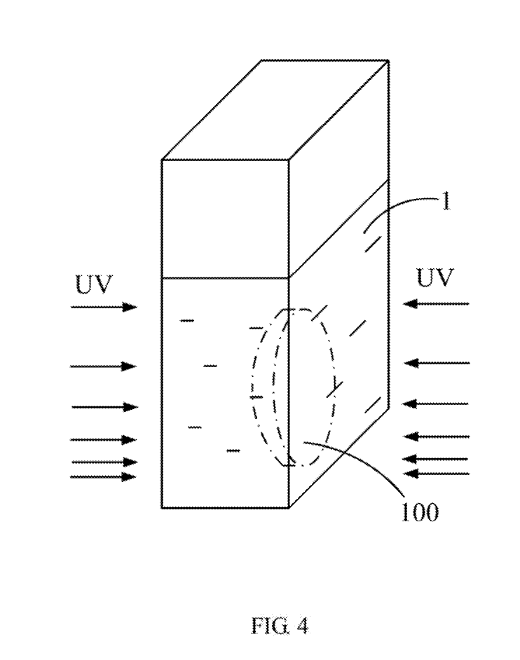

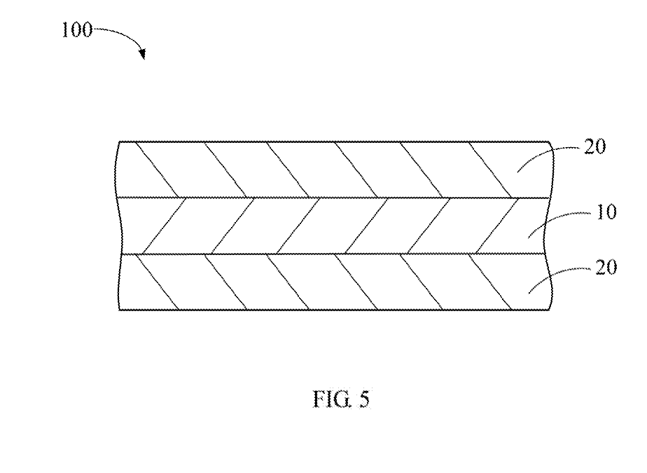

At block 103, referring to FIGS. 4 and 5, the photochromic coating solution 1 containing the ophthalmic lens body 10 is heated or exposed to ultraviolet radiation, thereby causing a portion of the photochromic coating solution 1 to polymerize and form a photochromic layer 20 on surfaces of the ophthalmic lens body 10. The photochromic molecule-cyclodextrin inclusion compounds are dispersed in the photochromic layer 20. Thus, the photochromic ophthalmic lens 100 is formed.

During the polymerizing reaction, the methacrylate resin and the initiator of the cross-linking agent are polymerized. The methacrylate groups of the methacrylate-bonded silane coupling agent and the initiator are also polymerized. Furthermore, since the methacrylate-bonded silane coupling agent has hydrolyzable groups Si—(OMe)₃, the methacrylate-bonded silane coupling agent and the ophthalmic lens body 10 can undergo a silylation reaction, thereby allowing the photochromic layer 20 to be bonded to the surface of the ophthalmic lens body 10.

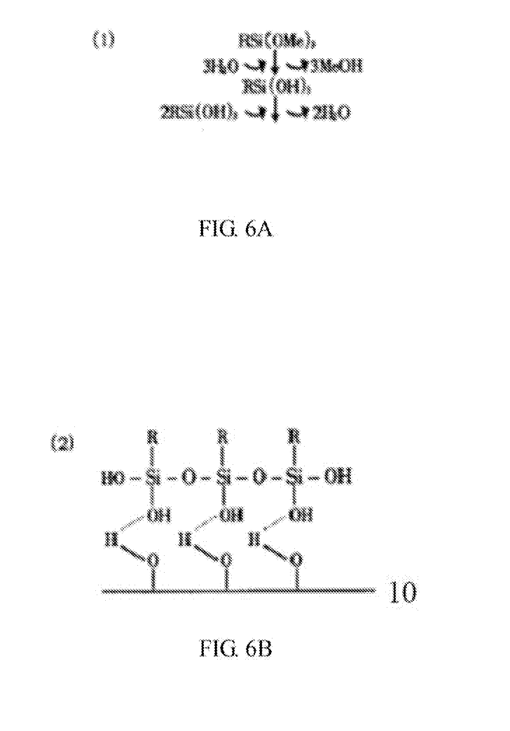

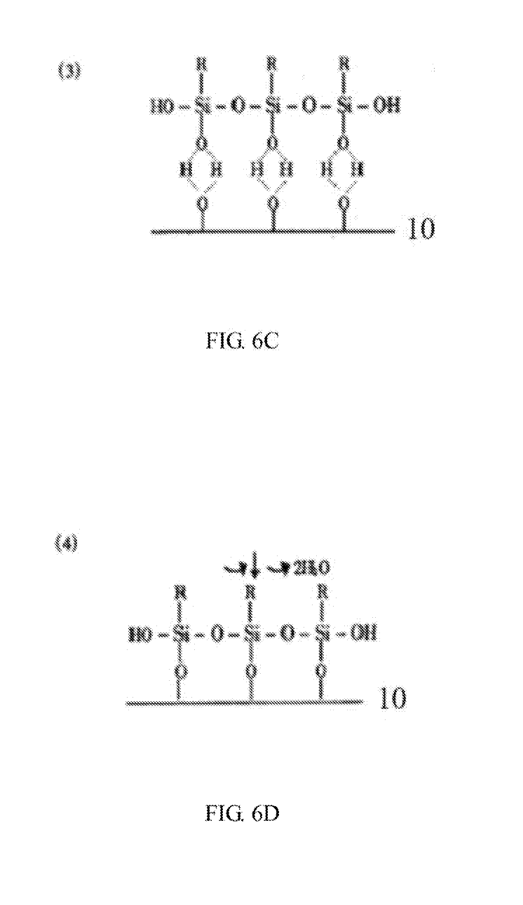

Referring to FIG. 6, the silylation reaction includes four stages, which are a hydrolysis stage (see FIG. 6A), a condensation stage (FIG. 6B), a hydrogen bond forming stage (FIG. 6C), and a covalent bond forming stage (FIG. 6D). In FIG. 6A, the hydrolysis stage is when the Si—(OMe)₃ groups of the methacrylate-bonded silane coupling agent RSi(OMe)₃ hydrolyze to generate Si—OH groups. In FIG. 6B, the condensation stage is when the Si—OH groups are dehydrated and condensed to produce a siloxane oligomer R₃Si₃O₂ (OH)₅. In FIG. 6C, the hydrogen bonds forming stage is when the Si—OH groups of the R₃Si₃O₂(OH)₅ react with the hydroxyl groups of the compound (chemical formular: A—OH) on the surface of the ophthalmic lens body 10 to form hydrogen bonds. In FIG. 6D, the covalent bonds forming stage is when the hydrogen bonds are dehydrated to form covalent bonds which connect the photochromic layer 20 to the ophthalmic lens body 10.

When the cyclodextrins are cyclodextrin derivatives having methacrylate groups, the methacrylate groups of the cyclodextrin derivatives can also react with other components when heated or exposed to ultraviolet radiation, to form covalent bonds. That is, the photochromic molecule-cyclodextrin inclusion compounds can be bonded to the photochromic layer 20 through the covalent bonds. Thus, the photochromic molecule-cyclodextrin inclusion compounds can be firmly bonded to the photochromic ophthalmic lens 100 to durably maintain the photochromic property of the photochromic ophthalmic lens 100 over a long period.

In at least one exemplary embodiment, the wavelength of the ultraviolet radiation, the temperature for heating, and the time period for ultraviolet radiation or heating is adjusted according to the type of the initiator.

In at least one exemplary embodiment, when the photochromic coating solution 1 containing the ophthalmic lens body 10 is exposed to ultraviolet radiation, an intensity of the ultraviolet radiation can gradually vary along an extending direction of the ophthalmic lens body 10. For example, as shown in FIG. 4, when the ophthalmic lens body 10 is immersed in the photochromic coating solution 1 and vertical, the intensity of the ultraviolet radiation gradually increases from top to bottom, thereby causing the photochromic layer 20 to have different degrees of polymerization along the extending direction of the photochromic layer 20. Thus, the photochromic layer 20 can have a gradation of the self-darkening property across the photochromic layer 20. That is, the photochromic ophthalmic lens 100 is a gradient photochromic ophthalmic lens.

### EXAMPLE 1

A photochromic solution of 100 L was formed in which benzopyrylospiran had a concentration of 0.01 mol/L. A cyclodextrin solution of 100 L was formed in which cyclodextrin had a concentration of 0.01 mol/L. The photochromic solution and the cyclodextrin solution were mixed to form photochromic molecule-cyclodextrin inclusion compounds. The photochromic molecule-cyclodextrin inclusion compounds, a methacrylate resin, TMSPMA, AIBN, and ethanol were mixed to form the photochromic coating solution 1. The photochromic molecule-cyclodextrin inclusion compounds had a mass percentage of 11.6% of a total mass of the photochromic coating solution 1, the methacrylate resin had a mass percentage of 12.6% of the total mass of the photochromic coating solution 1, the TMSPMA had a mass percentage of 3.85% of the total mass of the photochromic coating solution 1, the AIBN had a mass percentage of 0.7% of the total mass of the photochromic coating solution 1, and the ethanol had a mass percentage of 71.25% of the total mass of the photochromic coating solution 1. The ophthalmic lens body 10 was immersed in the photochromic coating solution 1 and heated at 75 degrees Celsius for 60 minutes to form the photochromic ophthalmic lens 100.

### EXAMPLE 2

A photochromic solution of 100 L was formed in which spiropyrans had a concentration of 0.01 mol/L. A cyclodextrin solution of 100 L was formed in which cyclodextrin had a concentration of 0.01 mol/L. The photochromic solution and the cyclodextrin solution were mixed to form photochromic molecule-cyclodextrin inclusion compounds. The photochromic molecule-cyclodextrin inclusion compounds, a methacrylate resin, TMSPMA, Irgacure1173, and ethanol were mixed to form the photochromic coating solution 1. The photochromic molecule-cyclodextrin inclusion compounds had a mass percentage of 17.6% of a total mass of the photochromic coating solution 1, the methacrylate resin had a mass percentage of 11.3% of the total mass of the photochromic coating solution 1, the TMSPMA had a mass percentage of 4.85% of the total mass of the photochromic coating solution 1, the Irgacure1173 had a mass percentage of 1.2% of the total mass of the photochromic coating solution 1, and the ethanol had a mass percentage of 65.05% of the total mass of the photochromic coating solution 1. The ophthalmic lens body 10 was immersed in the photochromic coating solution 1 and exposed to ultraviolet radiation of 365 nm for 10 minutes to form the gradient photochromic ophthalmic lens 100.

FIG. 5 illustrates an exemplary embodiment of a photochromic ophthalmic lens 100. The photochromic ophthalmic lens 100 can be spectacle glass having a photochromic function. The photochromic ophthalmic lens 100 comprises an ophthalmic lens body 10 and a photochromic layer 20 formed on surfaces of the ophthalmic lens body 10. A plurality of photochromic molecule-cyclodextrin inclusion compounds are dispersed in the photochromic layer 20.

In at least one exemplary embodiment, the photochromic layer 20 has different degrees of polymerization across the photochromic layer 20. Thus, when the photochromic molecule-cyclodextrin inclusion compounds undergo a reversible change of color upon exposure to certain wavelengths of light, the photochromic layer 20 can have a gradient change of color across the photochromic layer 20.

With the above configuration, the photochromic layer 20 is only formed on the surfaces of the ophthalmic lens body 10. Thus, when the photochromic ophthalmic lens 100 is exposed to certain wavelengths of light, only the photochromic layer 20 changes color. That is, there is no change in color of the ophthalmic lens body 10 itself.

Depending on the embodiment, certain of the steps of methods hereinbefore described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A method for making a photochromic ophthalmic lens comprising:
providing a photochromic coating solution comprising photochromic molecule-cyclodextrin inclusion compounds, a cross-linking agent, and a solvent, the photochromic molecule-cyclodextrin inclusion compounds comprising cyclodextrins and photochromic molecules entrapped in a cavity of the cyclodextrins;
immersing an ophthalmic lens body in the photochromic coating solution; and
heating or exposing the photochromic coating solution containing the ophthalmic lens body to ultraviolet radiation, thereby causing a portion of the photochromic coating solution to polymerize and form a photochromic layer with the photochromic molecule-cyclodextrin inclusion compounds dispersed therein on surfaces of the ophthalmic lens body, thereby forming the photochromic ophthalmic lens.

2. The method of claim 1, wherein the photochromic molecules are selected from a group consisting of spiropyrans, spiroperimidines, diarylethenes, fulgides, hexaarylbiimidazole, azobenzenes, benzopyrylospiran, and any combination thereof.

3. The method of claim 1, wherein the cross-linking agent comprises a methacrylate resin, a methacrylate-bonded silane coupling agent, and an initiator, and the cyclodextrins are cyclodextrin derivatives having methacrylate groups.

4. The method of claim 3, wherein the methacrylate-bonded silane coupling agent is 3-(trimethoxysilyl)propyl methacrylate.

5. The method of claim 1, wherein the initiator is a photoinitiator or a thermal initiator, the photoinitiator is selected from a group consisting of benzoin methyl ether, diethoxyacetophenone, benzoylphosphine oxide initiator, 1-hydroxycyclohexyl phenyl ketone, Darocure type initiator, Irgacure type initiator, and any combination thereof, and the thermal initiator is selected from a group consisting of 2,2′-azobis (2,4-dimethylpentanenitrile), 2,2′-azobis (2-methylpropanenitrile), 2,2′-azobis (2-methylbutanenitrile), azobisisobutyronite, peroxides, and any combination thereof.

6. The method of claim 3, wherein the photochromic molecule-cyclodextrin inclusion compounds have a mass percentage of about 11% to about 83% of a total mass of the photochromic coating solution, the methacrylate resin has a mass percentage of about 11% to about 41% of the total mass of the photochromic coating solution, the methacrylate-bonded silane coupling agent has a mass percentage of about 2% to about 32% of the total mass of the photochromic coating solution, the initiator has a mass percentage of about 0.05% to about 10% of the total mass of the photochromic coating solution, and the solvent has a mass percentage of about 10% to about 71.5% of the total mass of the photochromic coating solution.

7. The method of claim 1, wherein when the photochromic coating solution containing the ophthalmic lens body is exposed to ultraviolet radiation, an intensity of the ultraviolet radiation gradually vary along an extending direction of the ophthalmic lens body, thereby causing the photochromic layer to have different degrees of polymerization, so that the photochromic layer has a gradation of the self-darkening property across the photochromic layer.

8. The method of claim 1, wherein the solvent is alcohol or a mixed solution comprising water and alcohol.

9. The method of claim 8, wherein the solvent is ethanol.

10. The method of claim 1, wherein the photochromic molecule-cyclodextrin inclusion compounds are prepared by:
adding the photochromic molecules in ethanol, tetrahydrofuran, or acetone to form a photochromic solution;
adding the cyclodextrins in water to form a cyclodextrin solution;
mixing the photochromic solution and the cyclodextrin solution to form a mixed solution;
stirring the mixed solution to cause the photochromic molecules to be entrapped in the cavity of the cyclodextrins, thereby forming the photochromic molecule-cyclodextrin inclusion compounds; and
separating the photochromic molecule-cyclodextrin inclusion compounds from the mixed solution.

11. The method of claim 10, wherein the photochromic molecules have a concentration of about 0.0001 mol/L to about 0.1 mol/L in the photochromic solution, and the cyclodextrins have a concentration of about 0.0001 mol/L to about 0.1 mol/L in the cyclodextrin solution.

12. A photochromic ophthalmic lens comprising:
an ophthalmic lens body; and
a photochromic layer formed on surfaces of the ophthalmic lens body, photochromic molecule-cyclodextrin inclusion compounds dispersed in the photochromic layer, the photochromic molecule-cyclodextrin inclusion compounds comprising cyclodextrins and photochromic molecules entrapped in a cavity of the cyclodextrins.

13. The photochromic ophthalmic lens of claim 12, wherein the photochromic layer has different degrees of polymerization along an extending direction thereof, so that when the photochromic molecule-cyclodextrin inclusion compounds undergo a reversible change of color upon exposure to certain wavelengths of light, the photochromic layer has a gradient change of color across the photochromic layer.

14. The photochromic ophthalmic lens of claim 12, wherein the cyclodextrins are cyclodextrin derivatives having methacrylate groups, and the cyclodextrin derivatives are bonded to the photochromic layer through covalent bonds.

15. The photochromic ophthalmic lens of claim 12, wherein the photochromic molecules are selected from a group consisting of spiropyrans, spiroperimidines, diarylethenes, fulgides, hexaarylbiimidazole, azobenzenes, benzopyrylospiran, and any combination thereof.
